(19) United States
(12) Patent Application Publication
(10) Pub. No.: US 2008/0107924 A1
(43) Pub. Date: May 8, 2008

(54) FUEL CELL SYSTEM WITH REFILL ALARM

(76) Inventors: An-Pin Wang, Taipei County (TW); Chin-Yen Lin, Taipei County (TW); Yu-Chun Ko, Taoyuan County (TW); Kun-Wen Huang, Taipei County (TW); Su-Yun Yu, Tao-Yuan City (TW); Chiang-Wen Lai, Taipei City (TW)

Correspondence Address: NORTH AMERICA INTELLECTUAL PROPERTY CORPORATION, P.O. BOX 506, MERRIFIELD, VA, 22116, US

(21) Appl. No.: 11/612,478

(22) Filed: Dec. 19, 2006

(30) Foreign Application Priority Data
Nov. 7, 2006 (TW) 095141140

(51) Int. Cl. H01M 16/00; H01M 8/02; H02J 7/00

(52) U.S. Cl. 429/9; 429/34; 429/35; 320/101

(57) ABSTRACT

A fuel cell system has fuel cell units, a cycling fuel container with a vent device, a control device, a cycling pump, a fan, a fuel injection device, and an alarm coupled to the control device. The control device monitors a working voltage of the fuel cell system. If the working voltage is detected to be lower than a predetermined low value, the alarm is triggered to inform an operator or user to refill the cycling fuel container by using the fuel injection device.

### BACKGROUND OF THE INVENTION

1. Field of the Invention

The present invention relates to direct methanol fuel cell (DMFC) systems, and more particularly, to a DMFC system with a refill alarm.

The DMFC is inconvenient to carry, and leakage prevention is also a difficult problem. To solve these problems, an injection inlet is specially designed in the present invention, thus the concentration detecting device is no longer needed and only a cycling fuel container of methanol solution is used; therefore the size of DMFC system and the cost is efficiently decreased.

2. Description of the Prior Art

Known to those skilled in the art, direct methanol fuel cells (DMFC) require fuel of a certain concentration to perform normally. When a fuel cell is running continuously, fuel concentration in a cycling fuel container will decrease over time, and eventually, the fuel cell will stop running. Therefore, a sufficient supplement of fuel is needed to maintain performance of the fuel cell.

However, the volume and concentration of fuel to be added to the container is decided by concentration of the methanol solution. Therefore, in a conventional DMFC, a set of concentration detectors is used to detect the concentration of the methanol solution so as to determine the amount and concentration of fuel to be added.

The DMFC consumes not only methanol but also water. While the DMFC is in operation, water also needs to be added into a container. Therefore, a conventional DMFC system must comprise a water container, a methanol container, and a methanol solution cycling container. This increases the size of the DMFC system, making it less flexible for use in various applications. Moreover, the DMFC is inconvenient to carry, and leakage prevention is also a difficult problem.

### SUMMARY OF THE INVENTION

According to the present invention, a direct methanol fuel cell (DMFC) system comprises a plurality of fuel cell bodies, a cycling fuel container, a control device for monitoring a working voltage of the fuel cell system, a cycling pump, a fan, a fuel injection device, and an alarm coupled to the control device for activating when the control device detects that the working voltage is lower than a predetermined threshold voltage.

According to the present invention, a fuel cell charger system comprises a fuel cell set, a cycling fuel container, and a control circuit board. The control circuit board comprises a set of DC-DC converters, a plurality of ICs, and a plurality of electrical devices, and is capable of switching a voltage supplied by the fuel cell set to a loading voltage, and capable of controlling operation of the fuel cell charger system and optimizing the fuel cell charger system by switching between different operation modes automatically. The fuel cell charger system further comprises a cycling pump for supplying fuel to the fuel cell set, a fan for supplying oxygen to the fuel cell set and adjusting temperature of the fuel cell charger system, and a plurality of secondary batteries coupled to the control circuit board.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of one embodiment of a DMFC system according to the present invention.

FIG. 2 and FIG. 3 are schematic diagrams of one embodiment of refilling the DMFC system by a fuel injection device.

FIG. 4 is a diagram of operation voltage vs. time of the DMFC system under different starting concentrations.

FIG. 5 is a diagram of a fuel cell system that can increase output voltage in a short time.

FIG. 6 is an equivalent circuit diagram for outputting power in the fuel cell system of FIG. 5.

FIG. 7 is a diagram of a fan positioned at a rear of the fuel cell set according to the prior art.

FIG. 8 is a schematic diagram of a fuel cell system recycling water by a condenser in the prior art.

FIG. 9 is a schematic diagram of using a condensation gap covered by a gas permeable membrane to recycle water in the present invention.

### DETAILED DESCRIPTION

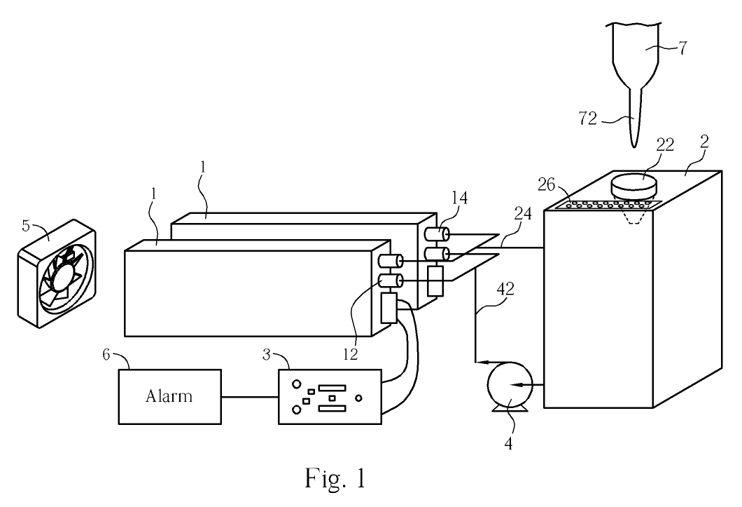

Please refer to FIG. 1. FIG. 1 is a schematic diagram of one embodiment of a DMFC system according to the present invention. As shown in FIG. 1, the DMFC system in the present invention comprises a plurality of fuel cell bodies 1, a cycling fuel container 2 with a vent device 26, at least a control device 3, a cycling pump 4, a fan 5, a fuel injection device 7, and an alarm 6 coupled to the control device 3. The alarm 6 can be a light signal, a sound signal, or a display panel. The above-mentioned control device comprises at least a control circuit board, an IC chip, or an electrical device.

As shown in FIG. 1, a body of the cycling fuel container 2 comprises a non-return injection inlet 22, which is shaped to match the shape of the fuel injection head 72 of the fuel injection device 7 and can be positioned on either a top surface of the cycling fuel container 2 or on sidewall of the cycling fuel container 2. In addition, the vent device 26 can expel the gas produced by a reaction. The vent device 26 can be a gas permeable membrane or another device which only allows air to permeate in and out of the cycling fuel container 2. An outlet 42 of the cycling pump 4 connects to a fuel inlet 12 of the fuel cell body 1 and an exit 14 of the fuel cell body 1 connects to the cycling fuel container 2 by a fuel supply channel 24.

The DMFC system is designed without a concentration detector because when the fuel cell is running, concentration in the cycling fuel container is decreasing continuously so the output voltage will decrease too. Moreover, under a fixed loading current, the output voltage will decrease with output power. Therefore, in the present invention, the control device 4 is designed according to the relation between the fuel concentration and the output voltage. When the voltage is lower than a predetermined low value, the alarm is triggered to inform an operator or user to refill the cycling fuel container. After the fuel injection device injects an amount of fuel of a specific concentration, the DMFC system can perform normally again.

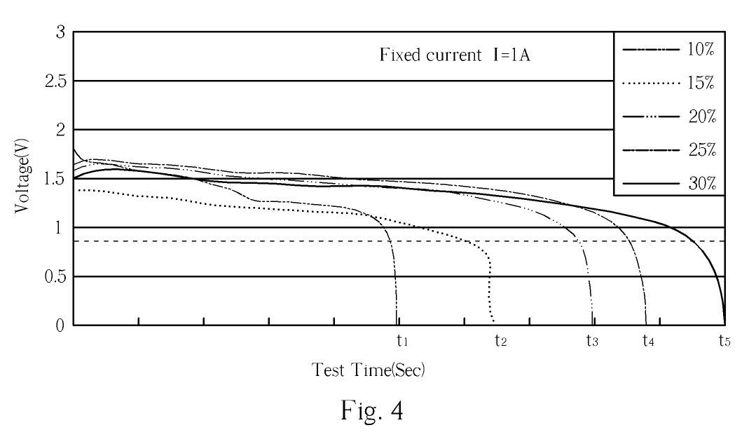

FIG. 4 is a diagram of the operation voltage vs. time of the DMFC system for different starting concentrations. Experimental curves of several volume percentages, such as 10%, 15%, 20%, 25%, and 30%, are depicted in FIG. 4. As shown in FIG. 4, for the different starting concentrations, the voltage of the DMFC system decreases from the highest working voltage (16V) to a voltage between 0.7V and 0.9V, after which the voltage decreases rapidly. The present invention preferably sets the predetermined low value to 0.8V in the control device 3 to control the DMFC system and make it perform continuously.

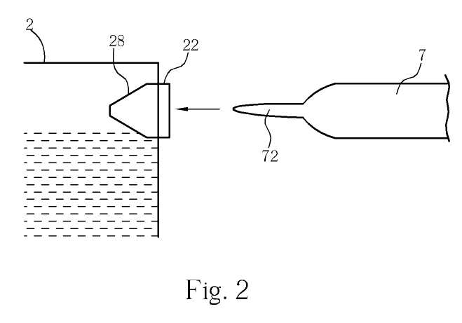

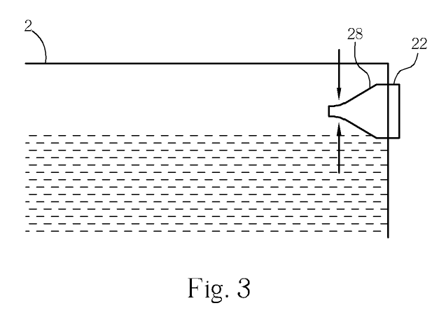

FIG. 2 and FIG. 3 depict schematic diagrams of one embodiment of the DMFC system refilled by the fuel injection device 7. The fuel injection device 7 can be a disposable or non-disposable fuel injection bottle comprising the fuel injection head 72 that matches the non-return injection inlet 22 on the cycling fuel container 2 in shape. According to one embodiment of the present invention, the non-return injection inlet 22 can be made of a high-elasticity, flexible plastic substrate or silica gel complex materials, and is especially resistive to solvent and chemical corrosion.

According to one embodiment of the present invention, a lid on the non-return injection inlet 22 is opened before fuel injection, the fuel injection head 72 is put into the non-return injection inlet 22, the fuel is refilled, and after fuel injection is finished, the non-return injection inlet 22 seals as the fuel injection head is being pulled out, so as to prevent fuel leakage, and the lid is put on to make a double-seal to prevent fuel leakage further.

The non-return injection device is specially designed for portable electronic devices. It solves the problem of fuel storage and makes electronic devices more easy to carry. The non-return injection device is made of a high-elasticity, flexible plastic substrate or silica gel complex materials so as to be resistant to chemical corrosion and have good mechanical qualities, and can be designed to form different shapes.

The non-return injection device in the present invention at least comprises the following advantages:

(1) The non-return injection device is a one-way system, which keeps fuel in the container from being spoiled by atmospheric pressure, humidity in the air and other environmental factors,

(2) The non-return injection device is specially designed in its mechanical structure to be capable of keeping fuel in the fuel container safely and to avoid fuel and methanol leakage,

(3) Fuel containers in the market are fixed on equipment, not portable, and are not capable of being refilled by disposable fuel injection devices. The non-return injection device in the present invention is not only suitable for disposable or non-disposable injection bottles but also capable of changing fuel by the bottle as users demand.

As fuel cells run, water is produced on the cathode and condensed water will block a reaction surface between oxygen and the cathode, thus decreasing the efficiency of the fuel cells.

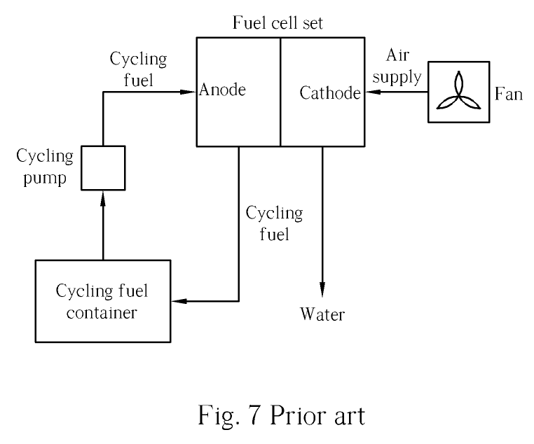

As shown in FIG. 7, in a conventional DMFC system, a fan is positioned at a rear of the fuel cell set to provide enough air for the reaction and to expel water produced by the cathode reaction. If water produced on the cathode can be recycled to dilute the high-concentration methanol for the fuel cell set, the size of the DMFC system can be reduced.

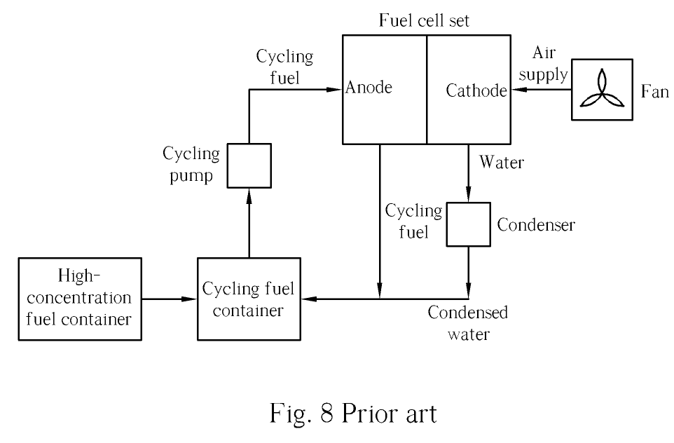

Another conventional art is use of a heat exchanger or a condenser to condense the water, as shown in FIG. 8. However, the heat exchanger or condenser will increase the size of the system. So in the present invention, the fuel cell system is designed without the heat exchanger or the condenser.

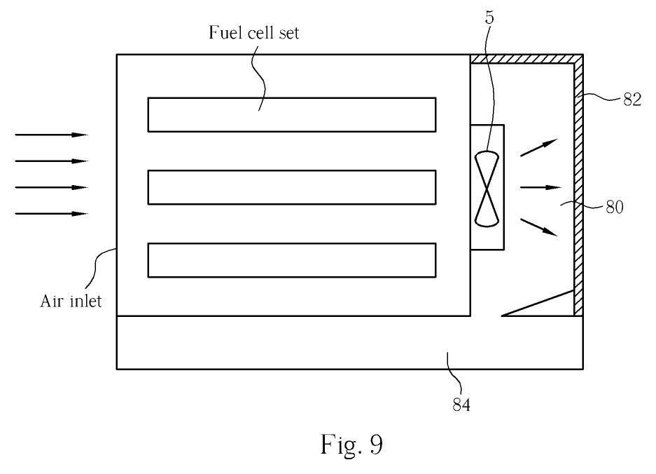

When fuel cells are running, heat is generated during the reaction, so the water produced at the cathode contains a certain heat. A fuel cell case is designed to use the heat of the water. As shown in FIG. 9, the fan 5 is positioned at the rear of the fuel cell set to provide enough air for the reaction and to expel the water produced by the cathode reaction. A condensation gap 80 is disposed around the fan 5 and the condensation gap 80 is covered by a gas permeable membrane 82 allowing the external air to permeate. When the water is expelled by the fan 5, the water condenses in the condensation gap 80. Thus, the water can be recycled to the cycling fuel container 84 to dilute the high-concentration methanol for the fuel cell set. Therefore, only a high-concentration fuel container is needed for the system, which greatly reduces the size of the container.

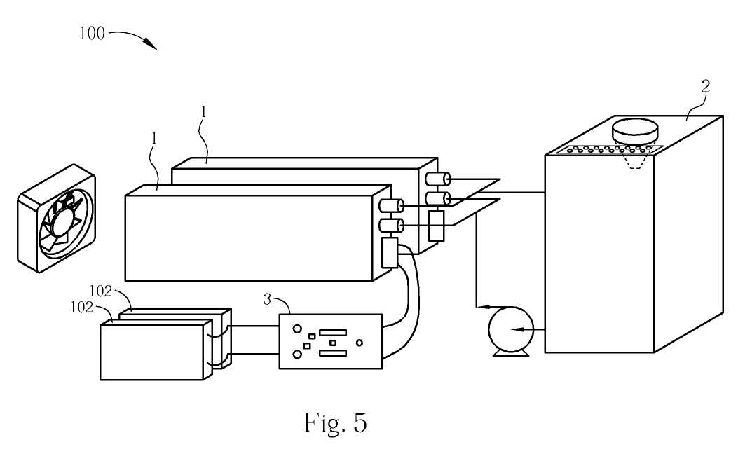

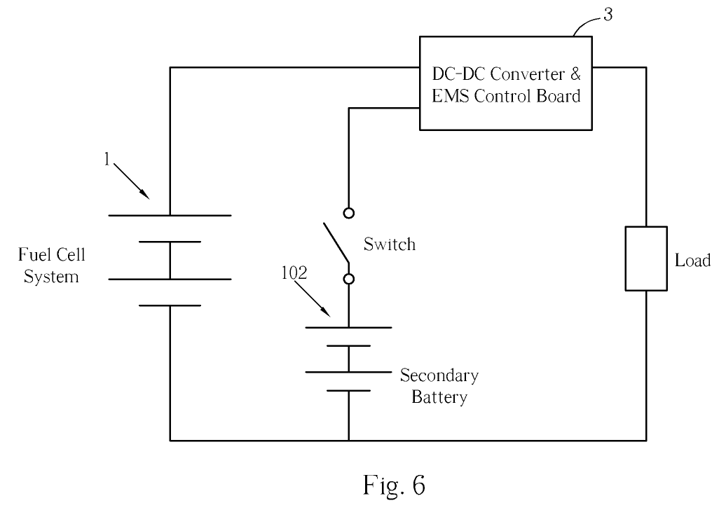

Please refer to FIG. 5 and FIG. 6. The present invention provides a fuel cell system, which supplies a higher voltage in a short period of time. FIG. 5 depicts a fuel cell system, which can increase output voltage in a short time. Especially when power output of the fuel cell is insufficient to support functions drawing on the power provided by the fuel cell, this equipment can solve the problem efficiently. FIG. 6 shows an equivalent circuit diagram for outputting power in the fuel cell system in FIG. 5.

As shown in FIG. 5, a fuel cell charger system 100 comprises a plurality of fuel cell bodies 1, a plurality of secondary batteries 102, a cycling fuel container 2 with a fuel injection device, at least a control circuit board 3 and other peripheral components, such as a fan and a cycling pump. The cycling pump is utilized to supply the fuel to the fuel cell set. The fan is utilized for supplying oxygen to the fuel cell set and adjusting the temperature of the fuel cell charger system.

The secondary batteries 102 can be any rechargeable batteries, such as Li-ion batteries, nickel-zinc batteries and polymer batteries. The control circuit board 3 comprises at least a set of DC-DC converters, a plurality of ICs and a plurality of electrical devices, which are capable of switching the voltage supplied by the fuel cell set to the loading voltage, and are capable of controlling operation of the fuel cell charger system and optimizing the fuel cell charger system by switching between different operation modes automatically.

According to one embodiment of the present invention, when the fuel cell charger system is under a light loading status, only the fuel cell set 1 supplies electricity. When the load exceeds the maximum power the fuel cell set 1 can supply, the fuel cell charger system switches the operation mode through the control circuit board 3 automatically and the secondary batteries 102 are turned on to make a parallel connection with the fuel cell charger system. The output voltage supplied by the secondary batteries 102 is adjusted by the DC-DC converters to the same voltage the fuel cell supplies so as to avoid electricity waste due to the parallel connection being between different voltages.

When the secondary batteries 102 are depleted to a predetermined level, the system will warn the user not to operate under the high load, which causes insufficient system power supply. The fuel cell set will charge the secondary batteries 102 through the IC (not shown) of the control circuit board until the battery is charged to a certain level of electricity before turning off the fuel cell charger system. When the fuel cell charger system operates under the low load, the fuel cell charger system will detect the level of the secondary batteries. If the secondary batteries are not fully charged, the fuel cell set will charge the secondary batteries, so that the secondary batteries are prepared with sufficient power.

The secondary batteries 102 can supply high power in a short time, which makes them capable of recharging some high power consumption electric devices, such as notebooks. In the present invention, use of the fuel cells combined with several secondary batteries can supply higher output voltage. Therefore, the size of the fuel cell set can be decreased.

After the fuel cell set runs for a period of time, performance of the fuel cell set will decrease due to the following:

(1) Carbon dioxide blocks the reaction of the catalyst, and

(2) Methanol penetrates to the cathode.

A performance recovery procedure can be used to restore the performance of the fuel cell set, which comprises at least one of the following methods:

1) Pausing the supply of methanol solution by stopping the pump to slow down the reaction so as to expel the carbon dioxide efficiently;

2) Decreasing the reaction between air and the cathode by stopping the fan so as to expel the carbon dioxide efficiently;

3) After the carbon dioxide is expelled, turning on a balance of plant (BOP) and increasing loading to revive the catalyst.

The processes mentioned above are controlled by a microcontroller. After the fuel cell set has run for a period of time, the system will turn on the performance recovery procedure automatically to maintain the performance of the fuel cell set.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A direct methanol fuel cell (DMFC) system comprising:
a plurality of fuel cell bodies;
a cycling fuel container;
a least a control device for monitoring a working voltage of the fuel cell system;
a cycling pump;
a fan;
a fuel injection device; and
an alarm coupled to the control device for activating when the control device detects that the working voltage is lower than a predetermined threshold voltage;
wherein the control device comprises at least a control circuit board, an IC chip or an electrical device.

2. The DMFC system of claim 1, wherein the fuel injection device comprising a disposable fuel injection bottle comprising a fuel injection head.

3. The DMFC system of claim 2, wherein the cycling fuel container comprises a non-return injection inlet shaped corresponding to the shape of the fuel injection head.

4. The DMFC system of claim 3, wherein the non-return injection inlet comprises an element made of a high-elasticity, flexible plastic substrate or silica gel complex materials, and is resistive to solvent and chemical corrosion.

5. The DMFC system of claim 3, wherein the non-return injection inlet seals as the fuel injection head is pulled out to prevent fuel leakage, and a lid covers the non-return injection inlet to make a double-seal for preventing fuel leakage.

6. The DMFC system of claim 3, wherein the non-return injection inlet is positioned on a top surface of the cycling fuel container or on a sidewall of the cycling fuel container.

7. The DMFC system of claim 1, wherein an outlet of the cycling pump connects to a fuel inlet of the fuel cell body and an exit of the fuel cell body connects to the cycling fuel container by a fuel supply channel.

8. The DMFC system of claim 1, wherein the alarm comprises a light signal, a sound signal, or a display panel.

9. The DMFC system of claim 1, wherein after the fuel injection device injecting a certain amount of fuel having a certain concentration, the DMFC system can perform normally again.

10. The DMFC system of claim 1, wherein the cycling fuel container comprises a vent device.

11. A fuel cell charger system, comprising:
a fuel cell set;
a cycling fuel container;
a control circuit board comprising a set of DC-DC converters, a plurality of ICs, and a plurality of electrical devices, the control board capable of switching a voltage supplied by the fuel cell set to a loading voltage, and capable of controlling operation of the fuel cell charger system and optimizing the fuel cell charger system by switching between different operation modes automatically;
a cycling pump for supplying fuel to the fuel cell set;
a fan for supplying oxygen to the fuel cell set and adjusting temperature of the fuel cell charger system; and
a plurality of secondary batteries coupled to the control circuit board.

12. The fuel cell charger system of claim 11, wherein the secondary batteries are rechargeable.

13. The fuel cell charger system of claim 11, wherein the secondary batteries comprise any combination of Li-ion batteries, nickel-zinc batteries, and polymer batteries.

14. The fuel cell charger system of claim 11, wherein when the fuel cell charger system is under a light loading status, only the fuel cell set supplies electricity.

15. The fuel cell charger system of claim 11, wherein the fuel cell charger system switches the operation mode through the control circuit board automatically when the load exceeds a maximum power the fuel cell set can supply, the secondary batteries are turned on to form a parallel connection with the fuel cell charger system, and the output voltage supplied by the secondary batteries is adjusted by DC-DC converters to the same voltage the fuel cell supplies to avoid electricity waste due to the parallel connection between different voltages.

16. The fuel cell charger system of claim 11 further comprising means for warning users not to operate under a high load when the secondary batteries are depleted to a predetermined level.

17. The fuel cell charger system of claim 11, wherein the fuel cell set charges the secondary batteries through the IC of the control circuit board to a predetermined level before turning off the fuel cell charger system.

18. The fuel cell charger system of claim 11, wherein the fuel cell set charges the secondary batteries when the fuel cell charger system operates under low load if the secondary batteries are not fully charged to prepare the secondary batteries.

19. The fuel cell charger system of claim 11, wherein after the fuel cell set operates for a predetermined period of time, the fuel cell charger system turns on a performance recover procedure automatically.

20. The fuel cell charger system of claim 19, wherein the performance recover procedure comprises at least one of the following:
pausing the supply of methanol solution by stopping the pump to slow down the reaction so as to expel carbon dioxide efficiently;
decreasing a reaction between air and the cathode by stopping the fan so as to expel carbon dioxide efficiently;
turning on a balance of plant (BOP) and increasing loading to revive the catalyst after expelling carbon dioxide.

21. The fuel cell charger system of claim 11, wherein the fan is positioned at a rear of the fuel cell set to provide enough air for a reaction and to expel water produced by the cathode reaction, wherein a condensation gap is disposed around the fan, the condensation gap is covered with a gas permeable membrane for allowing permeation of external air, and when the water is expelled by the fan, the water condenses in the condensation gap to recycle the water to the cycling fuel container to dilute high-concentration methanol for the fuel cell set.
